(19) United States
(12) Patent Application Publication
(10) Pub. No.: US 2008/0193063 A1
(43) Pub. Date: Aug. 14, 2008

(54) Linear motion guide device having ball retaining structure

(76) Inventors: Scotte Chen, Taichung (TW); Tsung Jen Chen, Taichung (TW)

Correspondence Address: CHARLES E. BAXLEY, ESQUIRE, 90 JOHN STREET, SUITE 309, NEW YORK, NY, 10038, US

(21) Appl. No.: 11/291,690

(22) Filed: Dec. 1, 2005

(51) Int. Cl. F16C 29/06

(52) U.S. Cl. 384/45

(57) ABSTRACT

A linear motion guide device includes a housing having a chamber formed by two side walls, a casing engaged in the chamber of the housing and having a space formed by two side fences, for slidably receiving an elongate track rail, the casing includes one or more channels formed in each of the side fences and faced toward the side walls of the housing and one or more channels faced toward the track rail. A number of rolling members are received in the channels of the casing, and the casing includes a ball retaining structure having one or more ribs extended into each of the channels for engaging with and for stably retaining the rolling members in the channels of the casing respectively.

### BACKGROUND OF THE INVENTION

1. Field of the Invention

The present invention relates to a linear motion guide device, and more particularly to a linear motion guide device having a structure for stably retaining balls or rollers therein, without additional ball retaining devices.

2. Description of the Prior Art

Various kinds of typical linear motion guide devices have been developed and comprise a bearing device or a slider slidably attached onto and movable along an elongate track rail which is normally arranged or disposed on a stationary portion, such as a bed of a machine tool, for guiding a movable member, such as a table along the elongate track rail.

For example, U.S. Pat. No. 6,109,789 to Chen discloses one of the typical linear motion guide devices and also comprises a bearing device or a slider slidably attached onto and movable along an elongate track rail, and a number of, such as four endless rolling elements or bearing elements disposed between the slider and the elongate track rail, for smoothly guiding the slider to move along the elongate track rail.

However, the slider is required to be drilled with four longitudinal bores therein, for slidably receiving one half of each of the endless rolling elements or bearing elements. It will be difficult and it will be expensive to accurately or precisely machine and form the longitudinal bores within the slider.

U.S. Pat. No. 6,652,146 to Lee discloses another typical linear motion guide devices also comprising four endless rolling elements or bearing elements disposed between a slider and an elongate track rail, for smoothly guiding the slider to move along the elongate track rail, and comprising two frames disposed within an outer housing, for retaining or attaching the endless rolling elements or bearing elements between the frames and the outer housing.

However, four complicated endless ball chains are required to be provided and having a number of spacers disposed therein, for spacing and for retaining the balls or rollers within the endless ball chains. Similarly, it will be difficult and it will be expensive to accurately or precisely form and manufacture the complicated endless ball chains.

The present invention has arisen to mitigate and/or obviate the afore-described disadvantages of the conventional linear motion guide devices.

### SUMMARY OF THE INVENTION

The primary objective of the present invention is to provide a linear motion guide device including a structure for stably retaining balls or rollers therein, without attaching additional ball retaining devices, and without expensive and complicated manufacturing or machining processes.

In accordance with one aspect of the invention, there is provided a linear motion guide device comprising a housing including a chamber formed therein, and defined by two side walls each having at least one surface formed therein, a casing engaged in the chamber of the housing, and including a space formed therein and defined by two side fences, for slidably receiving an elongate track rail, the casing including at least one first channel formed in each of the side fences and faced toward the side walls of the housing respectively, and including at least one second channel formed in each of the side fences and faced toward the track rail, and a number of rolling members received in the first channel and the second channel of the casing respectively, the casing includes a ball retaining structure having at least one rib extended into each of the first channel and the second channel of the casing, for engaging with and for stably retaining the rolling members in the first channel and the second channel of the casing respectively.

The first channel and the second channel of the casing are parallel to each other. The side walls of the housing each includes a surface formed thereon and aligned with and faced toward the first channel of the casing, to enclose the first channel of the casing, and to stably retain and confine the rolling members in the first channel of the casing. The housing includes a recess formed in each of the side walls and communicating with the chamber thereof, and defined by the surface of the side walls of the housing.

The track rail includes two sides each having a surface formed thereon and aligned with and faced toward the second channel of the casing, to enclose the second channel of the casing, and to stably retain and confine the rolling members in the second channel of the casing. The track rail includes two recesses formed in the sides thereof respectively, and each defined by the surface thereof. The rib of the casing includes a beak shape.

The casing includes two ball guide portions projected at ends of each of the side fences, and each having a semicircular shape, and aligned with the first channel and the second channel of the casing, and two boards secured to ends of the housing and each having two direction change paths formed therein, for receiving the ball guide portions of the casing respectively, and for coupling the first channel and the second channel of the casing together to form an endless ball rolling passage and to receive the rolling members.

The boards each includes a receptacle projected out of each of the side fences, and the direction change paths are formed in the receptacles of the boards respectively. The casing includes a third channel formed in each of the side fences and faced toward the side walls of the housing respectively, and includes a fourth channel formed in each of the side fences and faced toward the track rail, and parallel to the third channel of the casing, the boards each includes two ball guide portions provided thereon and each having a semicircular shape, and aligned with the third and the fourth channels of the casing respectively.

Two end caps are secured to the boards respectively and each having two direction change paths formed therein, for receiving the ball guide portions of the boards respectively, and for coupling the third and the fourth channels of the casing together to form an endless ball rolling passage and to receive the rolling members. The end caps each includes two orifices formed in each of the side fences and aligned with the third and the fourth channels of the casing respectively, for allowing the rolling members to move through the boards respectively.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a linear motion guide device in accordance with the present invention;

FIG. 2 is a perspective view of the linear motion guide device;

FIG. 3 is a cross sectional view of the linear motion guide device, taken along lines 3-3 of FIG. 2;

FIGS. 4, 5 are partial cross sectional views taken along lines 4-4, and 5-5 of FIG. 1 respectively;

FIG. 6 is a partial cross sectional view similar to FIG. 3, illustrating the combination or assembling of the elements as shown in FIGS. 4 and 5;

FIGS. 7, 8 are partial cross sectional views taken along lines 7-7, and 8-8 of FIG. 3 respectively, illustrating the operation of the linear motion guide device;

FIG. 9 is a partial exploded view of the linear motion guide device; and

FIG. 10 is an exploded view similar to FIG. 1, illustrating the other arrangement of the linear motion guide device.

### DETAILED DESCRIPTION OF THE PREFERRED EMBODIMENT

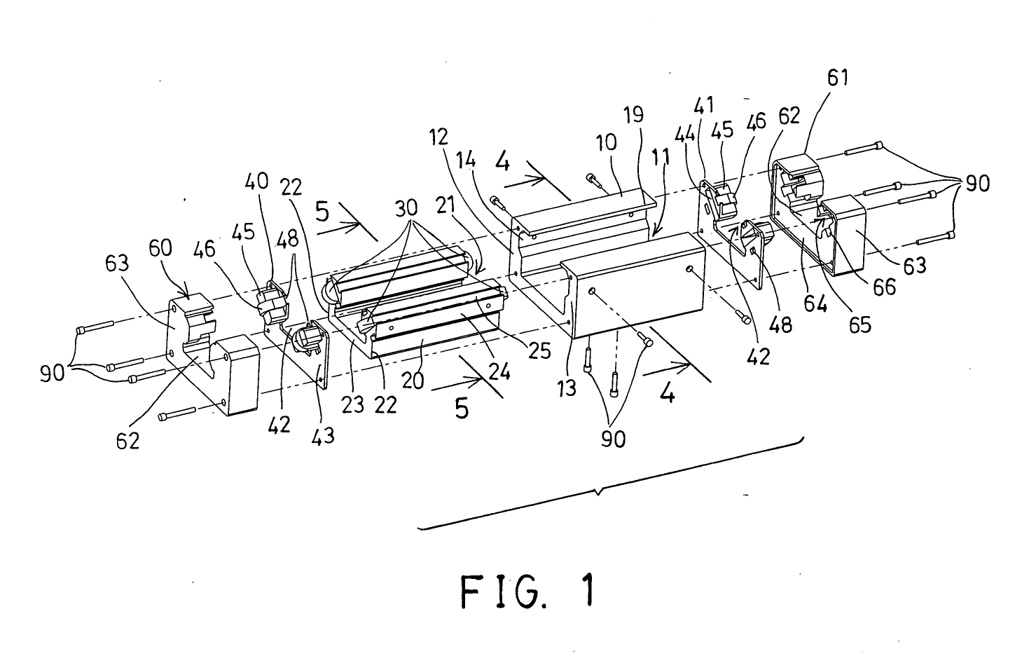

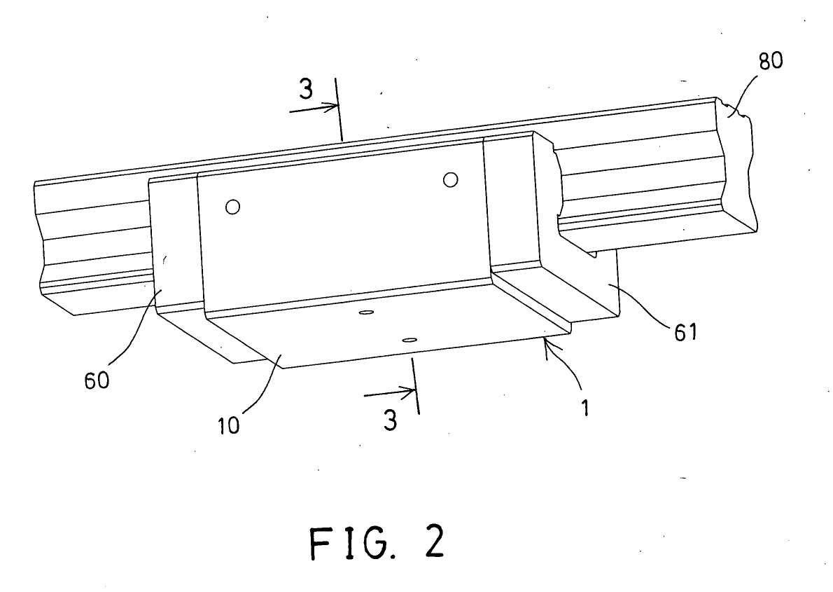

Referring to the drawings, and initially to FIGS. 1-3, a linear motion guide device in accordance with the present invention comprises a main body device or a slider 1 slidably attached onto and movable along an elongate track rail 80 which is normally arranged or disposed on a stationary portion, such as a bed of a machine tool (not shown), for guiding a movable member, such as a table (not shown) along the elongate track rail (80).

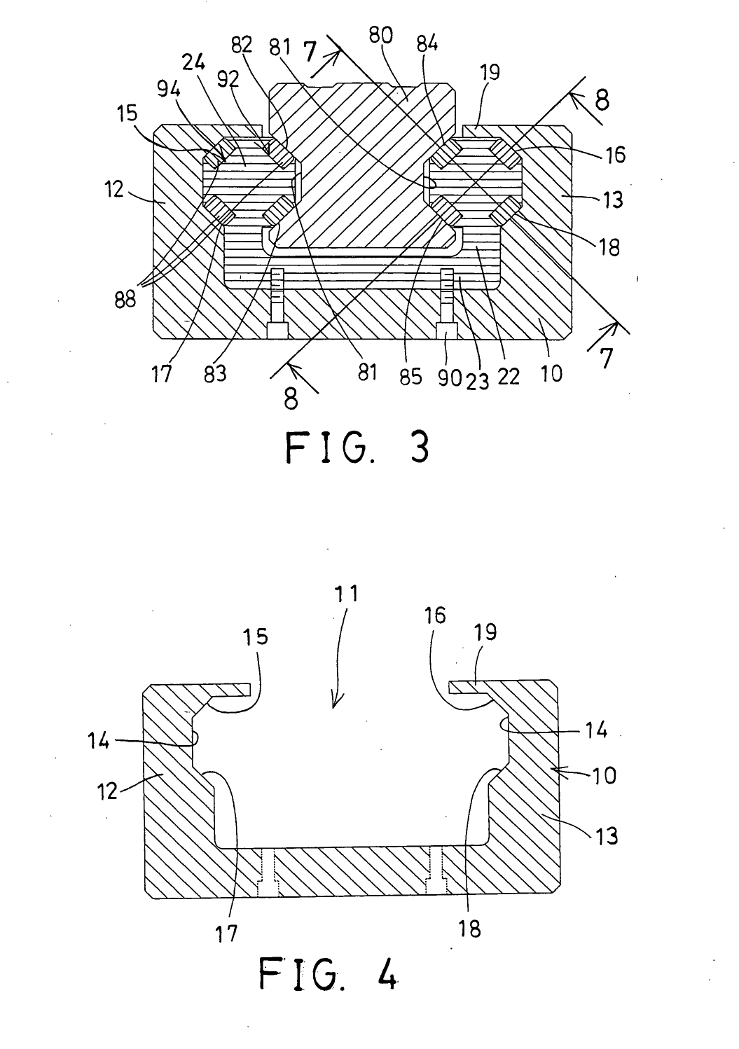

The slider 1 includes an outer housing 10 having a chamber 11 formed therein, best shown in FIGS. 3-4 and 6, and defined by two side walls 12, 13, and having a recess 14, formed in each of the two side walls 12, 13, and communicating with the chamber 11 thereof, and defined by two opposite surfaces 15, 17; 16, 18, such as inclined surfaces 15, 17; 16, 18. The outer housing 10 further includes a pair of flanges 19 extended laterally into the chamber 11 thereof from the side walls 12, 13 respectively.

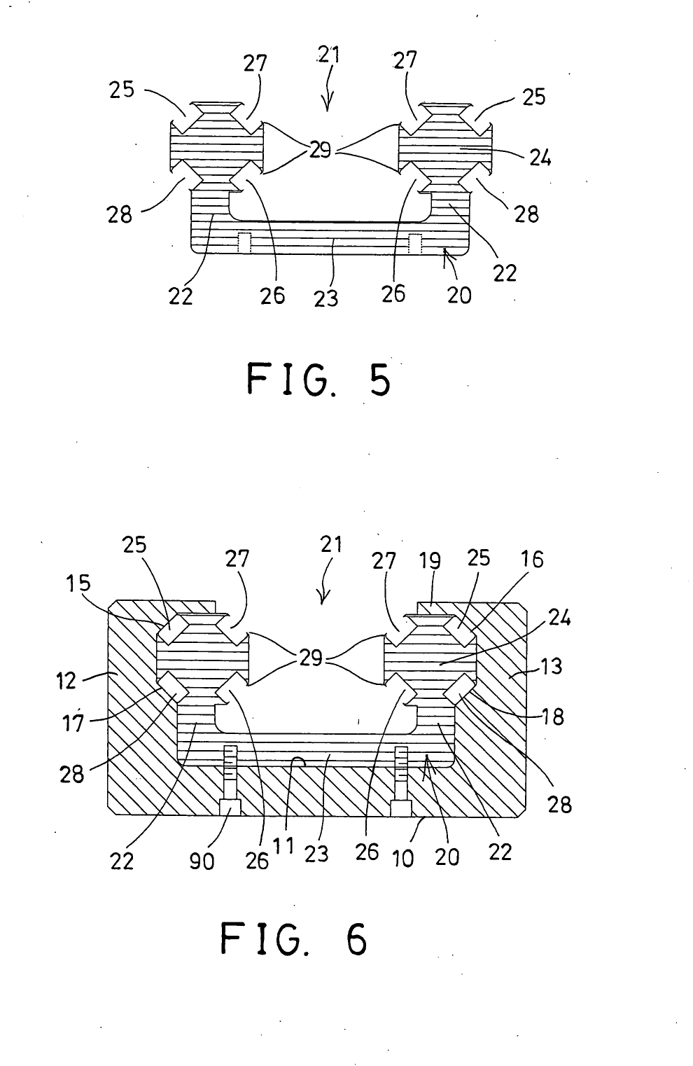

As best shown in FIGS. 3 and 5-6, a casing 20 is received and engaged into the chamber 11 of the outer housing 10, and secured to the outer housing 10 with such as fasteners 90, or the like, and also includes a space 21 formed therein and defined by two side fences 22 and a bottom fence 23, for slidably receiving the elongate track rail 80, and includes two enlarged heads 24 formed or provided on top or on the free end portions of the side fences 22 respectively, and having four or two pairs of opposite channels 25, 26, 27, 28 formed therein and spaced away from each other. The channels 25, 28 are faced toward the side walls 12, 13 of the housing 10 respectively, and the other channels 26, 27 are faced toward the track rail 80.

For example, the pair of channels 25, 26 are oppositely formed on the respective head 24 and parallel to each other, and the other pair of channels 27, 28 are also oppositely formed on the respective head 24 and also parallel to each other, but arranged substantially perpendicular to the pair of channels 25, 26 of the respective head 24, for slidably receiving balls or rollers or rolling members 88 therein (FIGS. 3, and 7-8), and for allowing the rolling members 88 to slide along the channels 25, 26, 27, 28 of the head 24 respectively.

The heads 24 each includes a ball retaining structure 29 having one or more, such as two bent segments or beak-shaped ribs 29 oppositely extended into each of the channels 25, 26, 27, 28, for engaging with and for stably retaining the rolling members 88 in the channels 25, 26, 27, 28 of the head 24 respectively, without additional ball retaining devices, and thus for preventing the rolling members 88 from being disengaged from the head 24. The flanges 19 of the outer housing 10 may further stably retain the casing 20 within the chamber 11 of the outer housing 10.

As best shown in FIGS. 3 and 6, the channels 25, 28 of the heads 24 are aligned with or faced toward the surfaces 15, 17 and 16, 18 of the outer housing 10 respectively, which may enclose or block the channels 25, 28 of the heads 24, for further stably retaining and confining the rolling members 88 in the channels 25, 28 of the head 24 respectively, without additional ball retaining devices.

As also shown in FIGS. 3 and 6, the elongate track rail 80 includes two side recesses 81 formed therein, and each defined by two opposite surfaces 82, 83; 84, 85, such as inclined surfaces 82, 83; 84, 85, for aligning with the channels 27, 26 of the heads 24 respectively, and for enclosing or blocking the channels 27, 26 of the heads 24, for further stably retaining and confining the rolling members 88 in the channels 27, 26 of the head 24 respectively, without additional ball retaining devices.

The casing 20 includes four or two pairs of ball guide portions 30 projected at the ends of the head 24 respectively (FIGS. 1, 7, 8), and each having a semicircular shape, and aligned with the channels 25, 26 of the head 24 respectively. Two boards 40, 41 and two end caps 60, 61 are secured to the ends of the housing 10 with such as fasteners 90, or the like, and each also includes a space 42, 62 formed therein and defined by two side fences 43, 63, and aligned with the space 21 of the casing 20, for slidably receiving the elongate track rail 80. It is preferable that the end caps 60, 61 each includes a depression 64 formed therein (FIGS. 1, 7, 8) for stably receiving the boards 40, 41 respectively.

The boards 40, 41 each includes two direction change paths 44 formed therein, such as formed in the side fences 43 respectively, and each defined by a receptacle 45 that is projected or extended out of the side fences 43 of the boards 40, 41 respectively, for receiving the ball guide portions 30 of the casing 20 respectively, and for coupling the channels 25, 26 of the head 24 together to form an endless ball rolling passage and to guide the balls or rollers or rolling members 88 to enter and to leave the channels 25, 26 of the head 24 respectively.

The boards 40, 41 each further includes two ball guide portions 46 provided thereon, or extended from the receptacles 45 of the side fences 43 respectively, and each also having a semicircular shape, and aligned with the other channels 27, 28 of the head 24 respectively. The boards 40, 41 each further includes two orifices 48 formed in each of the side fences 43, and also aligned with the channels 27, 28 of the head 24 respectively, for allowing the balls or rollers or rolling members 88 to enter and to leave the channels 27, 28 of the head 24 and to move through the boards 40, 41 respectively.

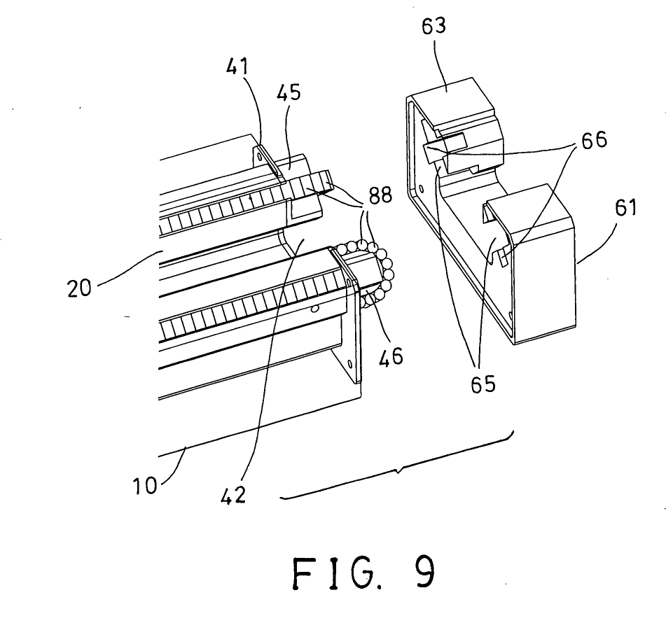

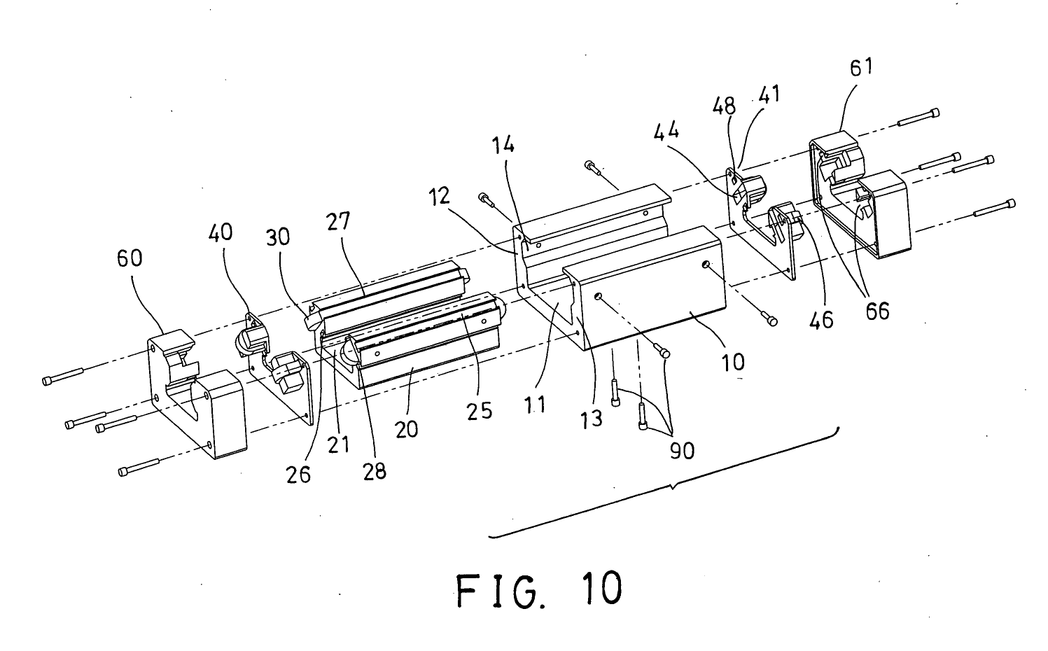

The end caps 60, 61 each includes a compartment 65 formed therein (FIG. 9) for snugly receiving the receptacles 45 of the boards 40, 41 respectively, and each also includes two direction change paths 66 formed therein, such as formed in the side fences 63 respectively, for receiving the ball guide portions 46 of the boards 40, 41 respectively, and for coupling the channels 27, 28 of the head 24 together to form an endless ball rolling passage and to guide the balls or rollers or rolling members 88 to enter and to leave the channels 27, 28 of the head 24 respectively.

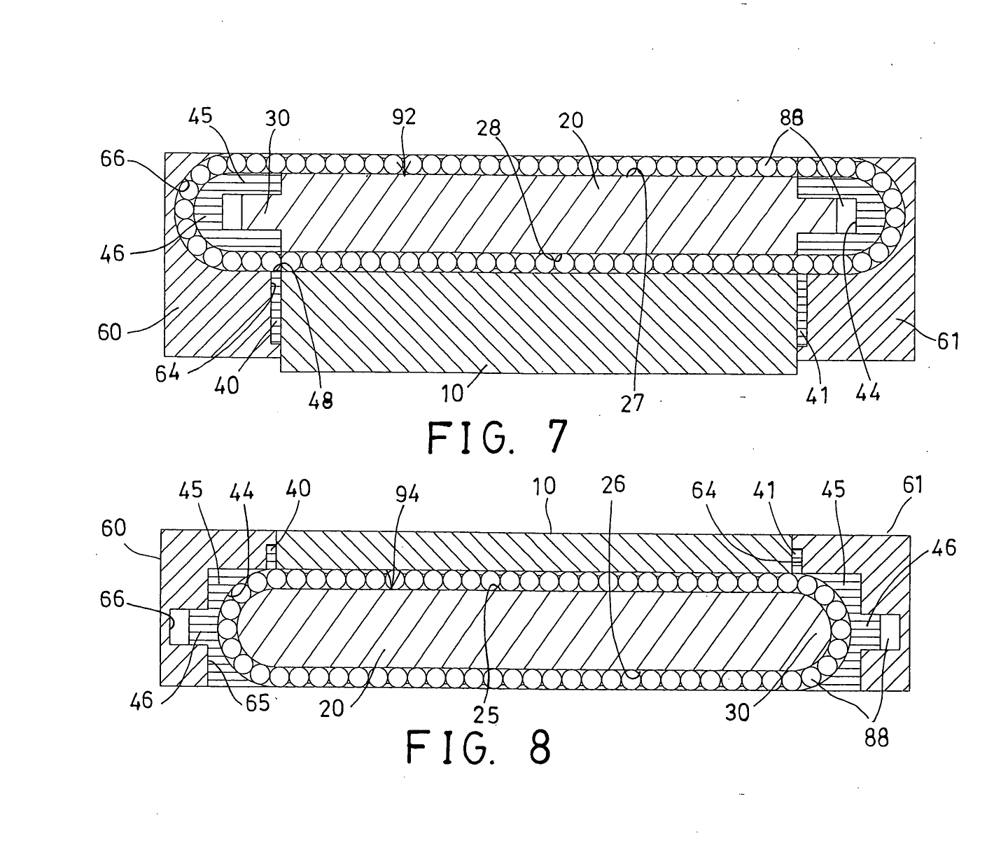

As shown in FIG. 7, the channels 27, 28 of the head 24 and the orifices 48 of the boards 40, 41 and the ball guide portions 46 of the boards 40, 41 and the direction change paths 66 of the end caps 60, 61 may be provided to form an endless ball rolling passage 92 and to slidably receive the balls or rollers or rolling members 88. As shown in FIG. 8, the channels 25, 26 of the head 24 and the ball guide portions 30 of the casing 20, and the direction change paths 44 of the boards 40, 41 may also be provided to form an endless ball rolling passage 94 and to slidably receive the balls or rollers or rolling members 88.

The slider 1 may thus include two pairs of endless ball rolling passages 92, 94 that are perpendicular to each other, best shown in FIGS. 3, 7, 8, for allowing the slider 1 to have a compact configuration. In addition, the channels 25, 26, 27, 28 of the head 24 may be easily formed and machined by the manufacturers. The conventional linear motion guide devices failed to provide and to teach a slider 1 having two pairs of endless ball rolling passages 92, 94 perpendicular to each other, and failed to provide and to teach a slider 1 including a ball retaining structure 29 having one or more bent segments or ribs 29 oppositely extended into each of the channels 25, 26, 27, 28, for engaging with and for stably retaining the rolling members 88 in the channels 25, 26, 27, 28 of the head 24 respectively, without additional ball retaining devices.

Alternatively, as shown in FIG. 10, the ball guide portions 30 of the casing 20 may also be aligned with the channels 27, 28 of the head 24 respectively, and the direction change paths 44 of the boards 40, 41 may also be provided to form an endless ball rolling passage 94 together with the channels 27, 28 of the head 24, and to slidably receive the balls or rollers or rolling members 88. The ball guide portions 46 of the boards 40, 41 may also be aligned with the channels 25, 26 of the head 24, and the direction change paths 66 of the end caps 60, 61 may be provided to form an endless ball rolling passage 92 together with the channels 25, 26 of the head 24 and the orifices 48 of the boards 40, 41.

Accordingly, the linear motion guide device in accordance with the present invention includes a structure for stably retaining balls or rollers therein, without attaching additional ball retaining devices, and without expensive and complicated manufacturing or machining processes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A linear motion guide device comprising:
a housing including a chamber formed therein, and defined by two side walls each having at least one surface formed therein,
a casing engaged in said chamber of said housing, and including a space formed therein and defined by two side fences, for slidably receiving an elongate track rail,
said casing including at least one first channel formed in each of said side fences and faced toward said side walls of said housing respectively, and including at least one second channel formed in each of said side fences and faced toward said track rail,
a plurality of rolling members received in said at least one first channel and said at least one second channel of said casing respectively, and
said casing including a ball retaining structure having at least one rib extended into each of said at least one first channel and said at least one second channel of said casing, for engaging with and for stably retaining said rolling members in said at least one first channel and said at least one second channel of said casing respectively.

2. The linear motion guide device as claimed in claim 1, wherein said at least one first channel and said at least one second channel of said casing are parallel to each other.

3. The linear motion guide device as claimed in claim 2, wherein said side walls of said housing each includes a surface formed thereon and aligned with and faced toward said at least one first channel of said casing, to enclose said at least one first channel of said casing, and to stably retain and confine said rolling members in said at least one first channel of said casing.

4. The linear motion guide device as claimed in claim 3, wherein said housing includes a recess formed in each of said side walls and communicating with said chamber thereof, and defined by said surface of said side walls of said housing.

5. The linear motion guide device as claimed in claim 2, wherein said track rail includes two sides each having a surface formed thereon and aligned with and faced toward said at least one second channel of said casing, to enclose said at least one second channel of said casing, and to stably retain and confine said rolling members in said at least one second channel of said casing.

6. The linear motion guide device as claimed in claim 5, wherein said track rail includes two recesses formed in said sides thereof respectively, and each defined by said surface thereof.

7. The linear motion guide device as claimed in claim 1, wherein said at least one rib of said casing includes a beak shape.

8. The linear motion guide device as claimed in claim 1, wherein said casing includes two ball guide portions projected at ends of each of said side fences, and each having a semicircular shape, and aligned with said at least one first channel and said at least one second channel of said casing, and two boards secured to ends of said housing and each having two direction change paths formed therein, for receiving said ball guide portions of said casing respectively, and for coupling said at least one first channel and said at least one second channel of said casing together to form an endless ball rolling passage and to receive said rolling members.

9. The linear motion guide device as claimed in claim 8, wherein said boards each includes a receptacle projected out of each of said side fences, and said direction change paths are formed in said receptacles of said boards respectively.

10. The linear motion guide device as claimed in claim 8, wherein said casing includes a third channel formed in each of said side fences and faced toward said side walls of said housing respectively, and includes a fourth channel formed in each of said side fences and faced toward said track rail, and parallel to said third channel of said casing, said boards each includes two ball guide portions provided thereon and each having a semicircular shape, and aligned with said third and said fourth channels of said casing respectively.

11. The linear motion guide device as claimed in claim 10, wherein two end caps are secured to said boards respectively and each having two direction change paths formed therein, for receiving said ball guide portions of said boards respectively, and for coupling said third and said fourth channels of said casing together to form an endless ball rolling passage and to receive said rolling members.

12. The linear motion guide device as claimed in claim 11, wherein said end caps each includes two orifices formed in each of said side fences and aligned with said third and said fourth channels of said casing respectively, for allowing said rolling members to move through said boards respectively.

13. A linear motion guide device comprising:
a housing including a chamber formed therein, and defined by two side walls,
a casing engaged in said chamber of said housing, and including a space formed therein and defined by two side fences, for slidably receiving an elongate track rail,
said casing including two endless ball rolling passages formed in each of said side fences and perpendicular to each other, for receiving rolling members.
